(19) United States
(12) Patent Application Publication
(10) Pub. No.: US 2009/0012936 A1
(43) Pub. Date: Jan. 8, 2009

(54) Management of data received by a mobile user or mobile users

(75) Inventor: Jochen Lothar Leidner, Edinburgh (GB)

Correspondence Address: HARRINGTON & SMITH, PC, 4 RESEARCH DRIVE, Suite 202, SHELTON, CT, 06484-6212, US

(73) Assignee: The University Court of the University of Edinburgh

(21) Appl. No.: 11/825,342

(22) Filed: Jul. 6, 2007

(51) Int. Cl. G06F 17/30; G06F 12/16

(52) U.S. Cl. 707/3; 707/204; 707/201; 707/E17.014

(57) ABSTRACT

An apparatus including: a memory storing a map having a plurality of access points at different respective locations on the map and storing metadata for each of the access points that includes data received by a user at the respective location of the access point; a communications port for receiving data relating to a user that indicates a location of the user and data received by the user at that location; and a processor configured to generate a new access point on the stored map at a location when the user, at the location, has received data and the location does not have an existing access point and configured to generate metadata for an access point for a location using the data received by the user at that location.

### FIELD OF THE INVENTION

Embodiments of the present invention relate to management of data received by a mobile user or mobile users.

### BACKGROUND TO THE INVENTION

When a person is at a certain location they may receive some data at that location. For example, they may pose a query about something they can see and receive, in reply, an answer.

The received data may be usable as a key by that person to help her recall what she did where.

The received data may also be useful to other persons.

### BRIEF DESCRIPTION OF VARIOUS EMBODIMENTS OF THE INVENTION

According to various embodiments of the invention there is provided an apparatus comprising:

a memory storing a map comprising a plurality of access points at different respective locations on the map and storing metadata for each of the access points that includes data received by a user at the respective location of the access point;

a communications port for receiving data relating to a user that indicates a location of the user and data received by the user at that location; and

a processor configured to generate a new access point on the stored map at a location when the user, at the location, has received data and the location does not have an existing access point and configured to generate metadata for an access point for a location using the data received by the user at that location.

According to various embodiments of the invention there is provided a method of manufacturing a knowledge map comprising: storing a map comprising a plurality of access points at different respective locations; generating a new access point on the map at a location when the user, at the location, receives data and the location does not have an existing access point; and associating with an access point for a location at least a portion of the data received by the user at that location.

According to various embodiments of the invention there is provided a storage device embodying a knowledge map comprising: a map comprising a plurality of access points at different respective locations; and metadata for each of the access points that includes data received by a user at location of the access point.

According to various embodiments of the invention there is provided a method comprising: receiving a query from a user when the user is at a location; providing data to the user in response to the query; automatically creating an association between at least the location of the user and the provided data; and using the association to enable access to the provided data at a later time.

According to various embodiments of the invention there is provided an apparatus comprising: an input for receiving a query from a user when the user is at a location an output for providing data to the user in response to the query; a processor configured to automatically create an association between at least the location of the user and the provided data and configured to use the association to enable access to the provided data at a later time.

According to various embodiments of the invention there is provided a storage device embodying computer program instructions which when loaded into a processor enables the processor to automatically create an association between a location of a user and data provided to the user at that location; and use the association to enable access to the provided data at a later time.

### BRIEF DESCRIPTION OF THE DRAWINGS

For a better understanding of various embodiments of the present invention reference will now be made by way of example only to the accompanying drawings in which:

FIG. 1 schematically illustrates a system for maintaining a knowledge record that records what a user wanted where;

FIG. 2 illustrates an example of a map; and

FIG. 3 illustrates a method for maintaining a map as a knowledge record.

### DETAILED DESCRIPTION OF VARIOUS EMBODIMENTS OF THE INVENTION

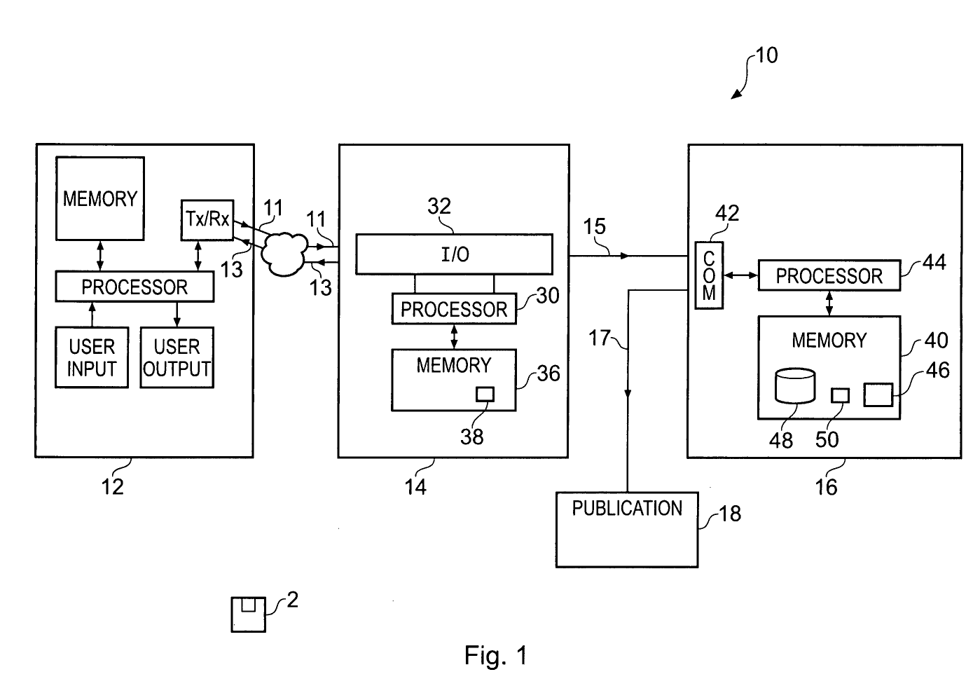

FIG. 1 schematically illustrates a system 10 for maintaining a knowledge record that records what a user wanted to know where. The knowledge record may be in the form of a map on which what the user wanted to know is recorded as metadata associated with a location on the map corresponding to where the user wanted to know it.

The system 10 may maintain a separate personal knowledge record or map for each one of a plurality of users. The knowledge record or map is personal in that it records what a particular user wanted to know where and is accessible to only that particular user.

The system 10 may maintain a shared knowledge record or map for a set of users. The knowledge record or map is shared in that it records what the set of users wanted to know where and may be freely available or available to the set of users.

The system 10 comprises: a mobile communication device 12; a data delivery server 14, which in this example is a query and answer (Q&A) server 14; a knowledge record server 16 which in this example is a mapping server 16; and a publication medium 18 which in this example is the World Wide Web (WWW).

The portable electronic communication device 12 may be any portable or mobile device that can be used to communicate with the data delivery server 14. It may, for example, be a mobile cellular telephone, a WiFi device, an in-car navigation system etc

The mobile communication device 12 may comprise: a processor 20; user input device 22 such as a microphone or keypad; a user output device 24 such as a display; a memory 26 and a radio transceiver 28 for communication with the data delivery server 14.

The processor 20 is connected to receive commands from the user input device 22, provide commands to the user output device 24, read from and write to the memory 26, and provide data to and receive data from the radio transceiver 28. The memory 26 typically stores computer program instructions that control the operation of the device 12.

As will be described in more detail later, the knowledge record server 16 needs to know the location of the device 12 when data is downloaded to the mobile communication device by the data download server 14. This location may be determined by a third party such as a cellular telephone operator and provided to the knowledge record server 16 directly for example using presence services or indirectly via the mobile communication device 12 and the data download server 14. Alternatively, the device 12 may itself determine its location using for example a global satellite positioning system or using triangulation from beacons such as cell-site base stations. Alternatively, the location may be estimated, taking into account “last known” locations stored in a mobile user's mobile user profile.

The user is able to use the user input device 22 to formulate a query and to send that query 11 to the query server 14. The query 11 may include an indication of the location of the user at that time and also include a user identifier. The query may contain either an information need or express a value judgement about existing metadata from other users previously near the user's current location.

The data delivery server 14 in this example is a query server. It may comprise:

a processor 30; an input/output interface 32 for receiving a query 11 from a user and for providing data 13 to the user in response to the query; and a memory 36 storing computer program 38.

The computer program 38 may arrive at the data delivery server 14 via an electromagnetic carrier signal or be copied from a physical entity 2 such as a computer program product, a memory device or a record medium such as a CD-ROM or DVD.

The processor 30 is connected to receive the query 11 from input/output interface 32 and provide a response 13 in response via the input/output interface 32 to the device 12. The processor 30 also provides data 15 to the knowledge record server 16 via the input/output interface 32 and reads from and writes to the memory 36. The memory 36 typically stores a computer program 38 that has instructions that control the operation of the query server 14. The computer program 38 enables the query server 14 to process a received query 11 and provide in return a response 13. The functionality to achieve this in one embodiment of the present invention, is described in ‘A Wireless Natural Language Search Engine’, Leidner, Jochen L., Proceedings of the 38^{th} Annual International ACM SIGIR Conference on Research and Development in Information Retrieval, Salvador, Bahia, Brazil, the contents of which are hereby included by reference. In this embodiment, the query corresponds to natural language questions or phrases, and the responses correspond to answer summaries. For example, in an example embodiment of the present invention, a tourist encountering a statue may ask his or her cell phone “Who crafted this statue?” near the statue's location. In another embodiment of the present invention, a user in a car may request recommendations about a restaurant or hotel he or she is driving by from his or her in-car navigation system (“this hotel's ratings”).

The server processor 30 is configured by the computer program 38 to automatically create an association between the location of the device 12 when the query 11 is received, the user identifier and the provided data 13.

The server processor 30 then sends the association to the mapping server as data 15. Data 15 may include a location, a user identifier, a query 11 and the provided answer data 13.

Although the described embodiment involves a user posing a query 11 using the device 12 and the query being answered 13 by the query server 14, it should be appreciated that in other embodiments the query server 13 may instead be a data delivery server 14 that provides data directly or indirectly requested by a user. In this embodiment, the association sent to the knowledge record server 16 as data 15 may include a location, the user identifier, and the provided data 13.

The knowledge record server 16 is, in the illustrated example, a mapping server 16. The server 16 provides access, at a later time, to at least some of the data 15 it receives from the data delivery server 14.

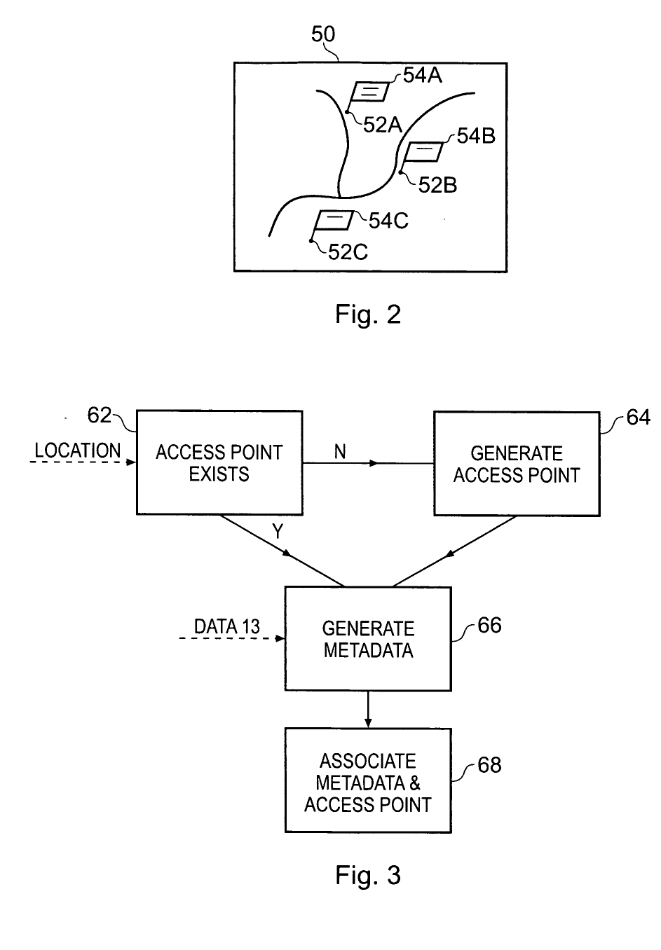

In the illustrated example, the server 16 maintains one or more maps. A map 50 is illustrated in FIG. 2. The map 50 comprises a plurality of access points 52A, 52B, 52C . . . at different respective locations on the map 50. The map 50 also includes metadata 54A, 54B, 54C for each of the access points 52A, 52B, 52C, respectively. Metadata 54 for a particular access point 52 includes the data 13 received by a user at the location of that particular access point 52. The metadata 54 may be fully or partially hidden when the map 50 is viewed. The availability of metadata for access points within the map creates a knowledge map.

A map 50 may be a user personal map. The metadata 54 for each of the access points then includes only data provided to a single user.

A map 50 may be a shared map. The metadata for access points may then includes data provided to multiple users. The shared map may identify a user to whom data was provided and may enable communication with that identified user. The identification of a user to whom data has been provided and whether and the extent to which that user may be communicated with may be controlled by a profile associated with the use. A profile is a record of a user's preferences such as the user's privacy settings.

The knowledge record server 16 may comprise: a memory 40 for storing a database 48 which is used to produce maps 50 and storing a computer program 46; a communications port 42 for communication with the data download server 14 and the publication medium 18; and a processor 44 for managing the database 48 which is used to produce maps 50.

The computer program 46 provides the logic and routines that enables the knowledge record server 16 to perform the method illustrated in FIG. 3. The computer program 46 may arrive at the knowledge record server 16 via an electromagnetic carrier signal or be copied from a physical entity 2 such as a computer program product, a memory device or a record medium such as a CD-ROM or DVD.

The processor 44 is connected to receive data 15 from the communications port 15 and provide a map 50 as data 17 to communications port 15 for publication on the publication medium 18. The processor 44 is arranged to read from and write to the memory 26. The computer program 46 controls the operation of the knowledge record server 16.

A method 60 performed by the knowledge record server is illustrated in FIG. 3.

At block 61, the knowledge record server 16 receives the data 15 from the data download server 14 The data 15 indicates a location L of a user/device 12 and the data 13 downloaded to that user/device 12 at that location.

At block 62, the knowledge record server determines whether the location L identified in data 15 corresponds to an existing access point 52 in the map 50.

When the location L lies within a threshold distance D of the location of an existing access point, then the existing access point is used for location L. The method proceeds to block 66.

When the location L lies outside a threshold distance D of the locations of all existing access points, then a new access point 52 is generated at location L as illustrated at block 84. The method then proceeds to block 66.

Block 64 may be the only mechanism for generating access points or additional mechanisms may be used such as user definition of access points.

The threshold distance D may vary from access point to access point and it may be dynamically varied.

At block 66, metadata 54 is generated for an access point 52 for location L using at least the data 13 received by the user at that location. For example, the metadata 54 for access point 52 at the location L may include the query 11 posed by the user at location L and also the answer 13 given to that query.

Then at block 68, the generated metadata 54 for location L and the access point 54 for location L are associated so that on the map 50 the metadata 54 for location L is available using the access point 54 for location L.

The association may occur by updating the database 48. The database 48 may include a record for each data download 13. A record may identify the user who posed a query, the location of the user when the query was posed, the generated metadata (e.g. query posed and the response provided) and the assigned access point.

It should be appreciated that although a location may be originally assigned to a particular access point, it may subsequently be re-assigned to a new or different access point. This may occur at the request of the user or automatically. It may, for example, occur when the number of database records associated with a particular access point exceeds a threshold.

The knowledge record server 16 may include a presence system which for example tracks the positions of a number of users.

When a user is located near an access point, the knowledge record server 16 may automatically download to the user the metadata 54 associated with the access point 52 in database 48.

When a user is located near a location having a record in the database, the knowledge record server 16 may automatically download to the user the metadata 54 associated with that record in the database 48.

As a user moves, the knowledge record server 16 may automatically update which portion of the map 50 is displayed to a user so that the displayed portion automatically includes a current location of the user.

The blocks illustrated in FIG. 3 may represent the control flow in an integrated circuit and/or steps in a method and/or sections of code in the computer program 46. The illustration of a particular order to the blocks does not necessarily imply that there is a required or preferred order for the blocks and the order and arrangement of the block may be varied.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus comprising:
a memory storing a map comprising a plurality of access points at different respective locations on the map and storing metadata for each of the access points that includes data received by a user at the respective location of the access point;
a communications port for receiving data relating to a user that indicates a location of the user and data received by the user at that location; and
a processor configured to generate a new access point on the stored map at a location when the user, at the location, has received data and the location does not have an existing access point and configured to generate metadata for an access point for a location using the data received by the user at that location.

2. An apparatus as claimed in claim 1, wherein the processor is configured to generate a new access point on the map when the user, at a location, receives an answer in response to a user generated query and the location does not have an existing access point

3. An apparatus as claimed in claim 1, wherein the processor is configured to generate a new access point on the map only when the user, at a location, receives an answer in response to a user generated query and the location does not have an existing access point

4. An apparatus as claimed in claim 1, wherein the processor is configured to determine that a location has an existing access point when the location lies within a threshold distance of the location of an existing access point.

5. An apparatus as claimed in claim 4, wherein the threshold distance is variable.

6. An apparatus as claimed in claim 1, wherein the processor is configured to reuse an existing access point on the map when the user, at a location, receives data and the location has an existing access point, wherein the processor is configured to reuse an existing access point by generating metadata for the existing access point using the data received by the user.

7. An apparatus as claimed in claim 1, wherein the map is a user personal map that comprises metadata for each of the access points that includes only data provided to a single user.

8. A method of manufacturing a knowledge map comprising:
maintaining a map comprising a plurality of access points at different respective locations;
generating a new access point on the map at a location when the user, at the location, receives data and the location does not have an existing access point; and
associating with an access point for a location at least a portion of the data received by the user at that location.

9. A method as claimed in claim 8, comprising: generating a new access point on the map when the user, at a location, receives an answer in response to a user generated query and the location does not have an existing access point

10. A method as claimed in claim 8, comprising: generating a new access point on the map only when the user, at a location, receives an answer in response to a user generated query and the location does not have an existing access point

11. A method as claimed in claim 8, comprising: determining that a location has an existing access point when the location lies within a threshold distance of the location of an existing access point.

12. A method as claimed in claim 11, wherein the threshold is variable.

13. A method as claimed in claim 8, comprising: re-using an existing access point on the map when the user, at a location, receives data and the location has an existing access point, wherein the access point is re-used by associating with the existing access point at least a portion of the data received by the user.

14. A storage device embodying a knowledge map comprising:
a map comprising a plurality of access points at different respective locations; and
metadata for each of the access points that includes data received by a user at location of the access point.

15. A method comprising:
receiving a query from a user when the user is at a location;
providing data to the user in response to the query;
automatically creating an association between at least the location of the user and the provided data; and
using the association to enable access to the provided data at a later time.

16. A method as claimed in claim 15, wherein access is via a map comprising a plurality of access points at different respective locations on the map and metadata for each of the access points that includes data provided to a user at the respective location of the access point.

17. A method as claimed in claim 16, wherein a new access point is generated automatically on the map at a location when a user, at the location, is provided with data and the location does not have an existing access point.

18. A method as claimed in claim 17, wherein metadata for an access point at a location is generated automatically using the data provided to the user at that location.

19. A method as claimed in claim 16, comprising reusing an existing access point on the map when a user, at a location, is provided with data and the location has an existing access point by generating metadata for the existing access point using the data provided to the user.

20. A method as claimed in claim 19, further comprising: determining that a location has an existing access point when the location lies within a threshold distance of the location of an existing access point.

21. A method as claimed in claim 16, wherein the map is a user personal map that comprises metadata for each of the access points that includes only data provided to a single user.

22. A method as claimed in claim 16, wherein the map is a shared map that comprises metadata that includes data provided to a multiple users.

23. A method as claimed in claim 22, wherein the shared map enables communication with other users.

24. A method as claimed in claim 15, comprising automatically downloading to a user data associated with a location when the user is at that location.

25. A method as claimed in claim 16, comprising automatically downloading to a user's mobile communication device metadata for an access point when the user is located at the access point.

26. A method as claimed in claim 16, comprising automatically updating which portion of the map is displayed to a user to include a current location of the user.

27. A method as claimed in claim 15, comprising the automatic sharing of data associated with a first location with another mobile user when a location of the another mobile user corresponds with the first location.

28. A method as claimed in claim 15, comprising the automatic sharing of data for a mobile user with other users, taking into account the user profile associated with the user.

29. An apparatus comprising:
an input for receiving a query from a user when the user is at a location;
an output for providing data to the user in response to the query;
a processor configured to automatically create an association between at least the location of the user and the provided data and configured to use the association to enable access to the provided data at a later time.

30. A storage device embodying computer program instructions which, when loaded into a processor, enables the processor to
automatically create an association between a location of a user and data provided to the user at that location; and
use the association to enable access to the provided data at a later time.
